(19) United States
(12) Patent Application Publication
(10) Pub. No.: US 2009/0019698 A1
(43) Pub. Date: Jan. 22, 2009

(54) METHODS OF MANUFACTURING AN ADHESIVE PRECOATED ORTHODONTIC APPLIANCE

(75) Inventor: James D. Christoff, Birchwood, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/779,931

(22) Filed: Jul. 19, 2007

(51) Int. Cl. A61C 3/00

(52) U.S. Cl. 29/896.11

(57) ABSTRACT

Methods of manufacturing an adhesive precoated orthodontic appliance are carried out by determining a quantity of the adhesive that is representative of a norm for bonding a particular appliance to a tooth that is representative of a patient population. An electronic template is provided to an orthodontic practitioner that includes data representing the norm. The practitioner may then elect to instruct the manufacturer to ship the selected appliance to the practitioner with a quantity of adhesive pre-applied to the appliance that differs from the determined norm.

### BACKGROUND OF THE INVENTION

1. Field of the Invention

This invention relates to methods of manufacturing orthodontic appliances that are used in the patient's oral cavity during the course of orthodontic treatment. More particularly, the present invention relates to methods of manufacturing an orthodontic appliance such as a bracket that has been precoated by the manufacturer with a quantity of orthodontic adhesive for bonding the bracket to a tooth.

2. Description of the Related Art

Orthodontic treatment involves movement of malpositioned teeth to orthodontically correct positions. Tiny orthodontic appliances known as brackets are connected to exterior surfaces of the patient's teeth, and an archwire is placed in a slot of each bracket. The archwire forms a track to guide movement of the teeth to desired positions for correct occlusion. End sections of the archwire are often received in appliances known as buccal tubes that are fixed to the patient's molar teeth. Adhesives are often used to bond orthodontic appliances directly to the surface of the tooth, using either direct or indirect methods known in the art.

For many years, it was common practice to apply orthodontic adhesive to the base of the appliance immediately before the appliance was placed on the tooth. In some instances, a quantity of adhesive was dispensed onto a mixing pad or dispensing well, and a spatula or other hand instrument was then used to apply a small dab of adhesive to each appliance. In other instances, a quantity of adhesive was dispensed from a syringe directly onto the base of the appliance.

Adhesive precoated brackets are known and offer significant advantages to the orthodontist. Adhesive precoated brackets have a bonding base upon which the manufacturer has applied a quantity of adhesive such as a photocurable adhesive. The brackets with the applied adhesive are then shipped to the practitioner in a container. Consequently, the practitioner can simply remove the brackets from the container and immediately place the brackets on the patient's tooth when desired.

The containers often used to package adhesive precoated brackets are generally made of materials that protect the adhesive from light, moisture and contaminants. Known containers include containers that receive only a single bracket. Optionally, the containers are received in a holder that is constructed for a single patient, and the holder carries a sufficient number of containers with their contained appliances for all or substantially all of the patient's teeth that are undergoing orthodontic treatment.

The practice of orthodontia is typically carried out by skilled professionals that develop preferred techniques after a period of time. Although practitioners generally encounter a variety of patients in their practice, their preferred techniques may remain relatively constant from one patient to the next. Consequently, it is advantageous for manufacturers to provide orthodontic appliances and related services in a manner that meets the preferred desires of the practitioner so that the efficiency of the practitioner is facilitated.

### SUMMARY OF THE INVENTION

The present invention is directed toward methods for manufacturing orthodontic appliances that have been precoated by the manufacturer with an amount of adhesive that best meets the needs of the practitioner. More specifically, the present invention is directed toward methods of identifying a standard or norm quantity of adhesive that might be preferred by a variety of practitioners, and then enabling the practitioner to deviate from the norm so that the appliances that are received by the practitioner include only the amount of adhesive that is desired by that practitioner. Such methods help ensure that the practitioner is able to work efficiently while treating the patient according to the practitioner's specific needs and desires.

In more detail, the present invention is directed to a method of manufacturing an adhesive precoated orthodontic appliance comprising:

selecting an orthodontic appliance and an orthodontic adhesive for bonding the appliance to a patient's tooth;

determining a quantity of the adhesive that is representative of a norm for bonding the selected orthodontic appliance to an average tooth of a patient population;

providing an electronic template to an orthodontic practitioner that includes data representing the norm;

receiving an instruction from the orthodontic practitioner to send the selected appliance to the practitioner with a quantity of adhesive applied to the appliance that differs from the norm; and

shipping the appliance to the practitioner with a quantity of adhesive applied to the appliance that is in accordance with the practitioner's instruction.

The present invention is beneficial for practitioners who may not know the precise quantity of adhesive in terms of a unit of measurement such as weight or volume that is suitable for bonding a particular appliance to a tooth. Instead, the practitioner is provided with information regarding an average quantity or norm quantity of adhesive that is preferred by a number of practitioners and/or suggested by the manufacturer for bonding that appliance to a particular tooth. The practitioner can then elect to order the appliance from the manufacturer with adhesive precoated on the base of the appliance in an amount equal to the norm, or in an amount that deviates from the norm by a greater or smaller quantity.

For example, some practitioner may elect to order the appliance from the manufacturer with a smaller quantity of adhesive than is typically supplied with adhesive precoated orthodontic brackets. These practitioners may prefer a smaller quantity of adhesive than the norm quantity in order to reduce the average amount of time that they might otherwise expend for removing adhesive flash during a bonding procedure. On the other hand, other practitioners may prefer to receive orthodontic appliances with an amount of adhesive that is greater than the norm amount of adhesive in order, for example, to help ensure that no voids or gaps are established in the adhesive layer in regions between the base of the appliance and the tooth.

The invention is described in more detail in the paragraphs that follow and is illustrated in the accompanying drawings.

### BRIEF DESCRIPTION OF THE DRAWINGS

FIG. 1 is an enlarged perspective view of an exemplary orthodontic appliance along with a quantity of adhesive that has been applied to the appliance for bonding the appliance to the surface of the patient's tooth;

FIG. 2 is a reduced-size perspective view of the appliance shown in FIG. 1 along with a container provided for shipping and storing the appliance before use, looking at the appliance from a different viewpoint;

FIG. 3 is a display diagram illustrating an exemplary appliance and adhesive selection dialog for software that includes a practitioner interface;

FIG. 4 is a block diagram illustrating an exemplary digital orthodontics system which includes a client computing device that presents the dialog shown in FIG. 3;

FIG. 5 depicts an example of a packaged orthodontic kit which includes a number of containers and adhesive precoated appliances such as the container and appliance shown in FIG. 2; and

FIG. 6 is a reduced-size perspective view of a packaged orthodontic kit that includes an indirect bonding tray with a plurality of adhesive precoated appliances according to another embodiment of the invention.

### DEFINITIONS

As used herein:

“Mesial” means in a direction toward the center of the patient's curved dental arch.
“Distal” means in a direction away from the center of the patient's curved dental arch.
“Occlusal” means in a direction toward the outer tips of the patient's teeth.
“Gingival” means in a direction toward the patient's gums or gingiva.
“Facial” means in a direction toward the patient's lips or cheeks.
“Lingual” means in a direction toward the patient's tongue.

### DETAILED DESCRIPTION OF THE PREFERRED EMBODIMENTS

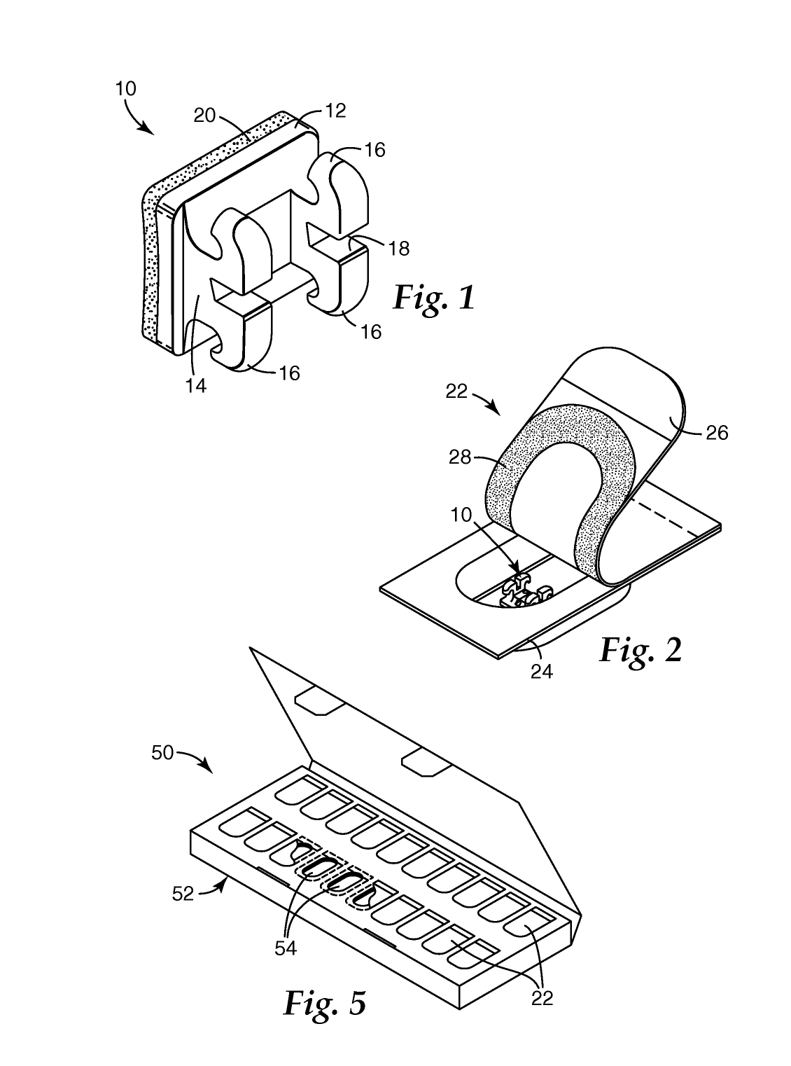

An exemplary orthodontic appliance 10 that is useful in carrying out the methods of the present invention is illustrated in FIG. 1. The appliance 10 in this illustration is known as an orthodontic bracket. However, other orthodontic appliances may be used in the methods of the present invention as well. Examples of other orthodontic appliances include buccal tubes, sheaths, cleats, buttons, and any other orthodontic device that is to be bonded to the patient's tooth structure by use of an orthodontic adhesive.

The appliance 10 includes a base 12 with an outwardly facing surface for bonding the appliance 10 to the enamel surface of a patient's tooth. The base 12 can be a flange made of metal, plastic, ceramic, and combinations thereof. Optionally, the base 12 can be a custom base having an outer surface comprising a cured adhesive layer(s) (i.e., cured single or multi-layer adhesives). The base 12 may also include grit, particles, grooves, protrusions, a chemical bond enhancement composition and combinations of the foregoing as well as any other structure or composition that enhances the ultimate bond of the appliance 10 to the patient's tooth.

The appliance 10 also includes a body 14 that extends outwardly from the base 12. Two pairs of spaced apart tiewings 16 are integrally connected to the body 14 and extend outwardly for receiving a ligature (not shown). An archwire slot 18 extends through the space between the tiewings 16 in a generally mesial-distal direction.

The appliance 10 (including the base 12, body 14 and tiewings 16) may be made of any one of a number of materials suitable for use in the oral cavity and having sufficient strength to withstand the correction forces applied during treatment. Suitable materials include, for example, metallic materials (such as stainless steel), ceramic materials (such as monocrystalline or polycrystalline alumina) and plastic materials (such as fiber-reinforced polycarbonate). Optionally, the base 12, the body 14 and the tiewings 16 are integrally made as a unitary component.

FIG. 1 also illustrates a quantity of orthodontic adhesive 20 that extends across the base 12 of the appliance 10. The adhesive 20 serves in whole or at least in part to help securely fix the appliance 10 to the patient's tooth by a bond having sufficient strength to resist unintended detachment from the tooth during the course of treatment.

As used herein, “adhesive” means any adhesive material that is used alone or in combination with other materials to bond the appliance 10 to the patient's tooth surface. The adhesive 20 may be a liquid, a semi-liquid, a paste or a solid material that is converted into a liquid, a semi-liquid or paste during the bonding procedure. Suitable compositions include composites, compomers, glass ionomers and resin-modified glass ionomers. Examples of light-curable adhesives include Transbond XT brand and Transbond LR brand adhesives, both from 3M Unitek. Examples of chemical curing adhesives include Sondhi brand Rapid-Set indirect bonding adhesive, Unite brand adhesive and Concise brand adhesive, all from 3M Unitek. An example of an adhesive that is both a light-curable adhesive and a chemical curing adhesive is Multi-Cure brand glass ionomer cement from 3M Unitek. Optionally, the adhesive 20 may be a fluoride-releasing adhesive, a self-etching adhesive, a self-priming adhesive, a color-changing adhesive or a combination thereof.

If the adhesive 20 is one component of a two-component adhesive such as the chemical curing adhesive materials mentioned above, the two components remain out of contact with each other during initial shipping and storage of the container 22. The two components are then brought into contact with each other either during or immediately before bonding the appliance 10 to a tooth. For example, if the adhesive 20 is a first component of a two-component adhesive, the second component may be applied by hand with a brush or other hand instrument to the first component after the appliance 10 is removed from the container 22. Alternatively, the second component may be applied to the surface of the tooth before the appliance 10 with the first component is placed on the tooth surface. Optionally, if one of the components comprises lyophilic ionic cement, the cement may be fixed to the base 12 by the methods described in U.S. Pat. No. 6,050,815 (Adam et al.).

Optionally, the adhesive 20 falls in one of the following classes in accordance with the practitioner's preferences for tooth treatment:

Class I: An adhesive that requires both etching of tooth enamel and a separate application of a primer to the tooth enamel.

Class II: An adhesive that requires etching but not necessarily a separate application of primer.

Class III: An adhesive that requires no treatment of the teeth other than cleaning.

Class I adhesives, which include some chemically cured adhesives, require the use of a suitable etchant such as phosphoric acid or bisphosphonic acid. Possible primers for use with class I adhesives include orthodontic primers such as Transbond MIP brand primer and Transbond XT brand primer from 3M Unitek and Ortho Solo brand primer from Ormco Corporation. A self-etching primer may possibly be used, such as Transbond Plus SEP brand primer from 3M Unitek. Optionally, the primer may include a photobleachable dye to ensure adequate coverage of the primer on the teeth, a small amount of fluoroalumina silicate glass (“FAS” glass) for providing fluoride release during treatment, a small amount of fumed silica for rheology control purposes, and/or a small amount of silanated quartz filler for enhanced fracture toughness.

Suitable class II adhesives, which include many conventionally light cured adhesives, do not require a separate priming step. If the adhesive is a multi-layer adhesive, the adhesive may include a layer of primer that first contacts the tooth during a bonding procedure. As mentioned previously, phosphoric acid or bisphosphonic acid may be used as an etchant. If the adhesive does not include a primer component, the etchant itself may function as a primer. An example of such a self-etching primer is Transbond Plus SEP brand primer from 3M Unitek. Optionally, the self-etching primer could incorporate the optional features described above for the class I adhesive.

Suitable class III adhesives avoid the need for etching and priming the teeth and may be referred to as “self-adhesive” compositions. With these adhesives, the practitioner need only clean the teeth prior to application of the orthodontic appliance in a typical bonding procedure. Suitable class III adhesives may include an acid component selected from a methacrylate phosphate (e.g., mono-HEMA phosphate, di-HEMA phosphate, glycerol dimethacrylate (“GDMA”) phosphate, a solution of a bisphosphonic acid in water or other solvent, and a bisphosphonic acid in powder form (using water for ionizing that is left on the teeth after tooth prophy and rinse). Other class III adhesives may include an ethylenically unsaturated component with acid functionality, an ethylenically unsaturated component without acid functionality, an initiator system, and filler. Optionally a class III adhesive may be essentially free of water. Examples of class III adhesives have been previously described, such as in published U.S. Patent Application Nos. 2005/0176844 (Aasen et al.), 2005/0175966 (Falsafi et al.) and 2005/0175965 (Craig et al.).

The class III adhesives described above can optionally incorporate fillers (e.g., a glass ionomer-type filler that binds the water in the usual glass ionomer setting reaction). In addition, any of the class III adhesives described above may incorporate the optional features described in connection with class I adhesives.

Adhesive materials useful in the present invention may optionally include components such as fluoride releasing agents as described, for example, in U.S. Pat. Nos. 3,814,717 (Wilson et al.) and 6,126,922 (Rozzi et al.); adhesive enhancing agents (e.g., titanates, zirconates) as disclosed, for example, in PCT International Publication No. WO2000/069393 (Brennan et al.); fillers; micro fillers; remineralisation agents; enzyme releasing agents; rheology enhancing agents; photobleachable dyes; thermochromic agents; and combinations thereof.

Optionally, the adhesive 20 preferably has an initial color remarkably different from dental structures. Color is preferably imparted to the adhesive 20 through the use of a photobleachable dye. The adhesive 20 preferably includes at least 0.001% by weight photobleachable dye, and more preferably at least 0.002% by weight photobleachable dye, based on the total weight of the adhesive. The adhesive 20 preferably includes at most 1% by weight photobleachable dye, and more preferably at most 0.1% by weight photobleachable dye, based on the total weight of the adhesive. The amount of photobleachable dye may vary depending on its extinction coefficient, the ability of the human eye to discern the initial color, and the desired color change.

The color formation and bleaching characteristics of the photobleachable dye varies depending on a variety of factors including, for example, acid strength, dielectric constant, polarity, amount of oxygen, ambient moisture, and the type and weight percent of filler and/or resin. However, the bleaching properties of the dye can be readily determined by irradiating the adhesive and evaluating the change in color. Preferably, at least one photobleachable dye is at least partially soluble in a hardenable resin.

Exemplary classes of photobleachable dyes are disclosed, for example, in U.S. Pat. Nos. 6,331,080 (Cole et al.), 6,444,725 (Trom et al.), and 6,528,555 (Nikutowski et al.). Preferred dyes include, for example, Rose Bengal, Methylene Violet, Methylene Blue, Fluorescein, Eosin Yellow, Eosin Y, Ethyl Eosin, Eosin bluish, Eosin B, Erythrosin B, Erythrosin Yellowish Blend, Toluidine Blue, 4′,5′-Dibromofluorescein, and combinations thereof. Reactint dyes may also be used.

The color change in the adhesive 20 is preferably initiated by light. Preferably, the color change is initiated using actinic radiation using, for example, a dental curing light which emits visible or near infrared (IR) light for a sufficient amount of time. The mechanism that initiates the color change in the adhesive 20 may be separate from or substantially simultaneous with the hardening mechanism that hardens the resin. For example, the adhesive 20 may harden when polymerization is initiated chemically (e.g., redox initiation) or thermally, and the color change from an initial color to a final color may occur subsequent to the hardening process upon exposure to actinic radiation.

The change in adhesive color from an initial color to a final color is preferably quantified by the color test described in U.S. Pat. No. 6,528,555 (Nikutowski et al.). Using that color test, a value of ΔE* is determined, which indicates the total color change in a 3-dimensional color space. The human eye can detect a color change of approximately 3 ΔE* units in normal lighting conditions. The color change in the adhesive 20 is preferably capable of having a color change, ΔE*, of at least 10; more preferably, ΔE* is at least 15; most preferably ΔE* is at least 20.

Useful methods for applying the adhesive 20 to the appliance 10 are described in U.S. Pat. No. 5,552,177 (Jacobs et al.). By cooling the adhesive as described in that reference, a flattened droplet of adhesive can be trimmed with a knife, laser or other cutting instrument and then weighed as needed to confirm that that a correct, precise quantity of adhesive remains. The trimmed adhesive droplet can then be placed on the base 12 of the appliance 10 while still maintained at a temperature below ambient temperature for convenient handling.

Referring to FIG. 2, the orthodontic appliance 10 together with the adhesive 20 as shown in FIG. 1 is received in a recess of a container 22. The container 22 includes a substrate 24 and a cover 26. The cover 26 is releasably connected to a flange of the substrate 24 by an adhesive such as a pressure-sensitive adhesive 28. The cover 26 is lifted away from substrate 24 to open the container 22 for removal of the appliance 10 when desired. In FIG. 2, the cover 26 has been peeled back from substrate 24 to partially open the container 22.

In preferred embodiments, the container 22 provides excellent protection against degradation of the adhesive 20 even after extended periods of time. If the adhesive 20 is a color-changing adhesive, the container 22 preferably is constructed to protect the dye or dyes that impart a color-changing feature to the adhesive 20. Such packages preferably effectively block the passage of actinic radiation over a broad spectral range, and as a result, the adhesive 20 does not prematurely harden or lose color during storage.

Preferably, the container 22 comprises a polymer and metallic particles. As an example, container 22 may be made of polypropylene that is compounded with aluminum filler or receives an aluminum powder coating as disclosed, for example, in published U.S. Patent Application No. 2003/0196914 (Tzou et al.). The combination of polymer and metallic particles provides a highly effective block to the passage of actinic radiation to color changing dyes, even though such dyes are known to be highly sensitive to light. Such containers also exhibit good vapor barrier properties. As a result, the rheological characteristics of the adhesive 20 are less likely to change over extended periods of time. For example, the improved vapor barrier properties of such containers provide substantial protection against degradation of the handling characteristics of adhesives so that the adhesives do not prematurely cure or dry or become otherwise unsatisfactory. Suitable covers 26 for such containers can be made of any material that is substantially opaque to the transmission of actinic radiation. Examples of suitable materials for cover 26 include laminates of aluminum foil and polymers. For example, the laminate may comprise a layer of polyethyleneterephthalate, adhesive, aluminum foil, adhesive and oriented polypropylene. Examples of other suitable materials for the container 22 and the cover 26 are described in U.S. Pat. Nos. 4,978,007 Jacobs et al.), 5,328,363 (Chester et al.), 5,575,645 (Jacobs et al.) and 5,636,736 (Jacobs et al.).

Optionally, the container 22 includes a release substrate in contact with the adhesive 20. The release substrate readily releases from the adhesive 20 when the appliance 10 is lifted from the container 22 to help ensure that the shape of the adhesive 20 is not unduly distorted. The release substrate may be a release coating applied to the bottom of the recess of the container 22 or an initially separate section of release material that is connected to the bottom of the recess. Suitable release substrates are described, for example, in U.S. Pat. No. 6,183,249 (Brennan et al.).

As another option, the container 22 does not include a release substrate. For example, the container 22 may include a substrate with at least one recess with an interior surface. The container 22 includes a means for positioning the orthodontic appliance 10 inside the recess such that the adhesive 20 does not separate from the appliance 10 upon removal of the appliance 10 from the recess. Preferably, the container 22 further includes a cover for the recess and a means for maintaining the cover in contact with the substrate. The means for positioning the orthodontic appliance 10 may include means for suspending the appliance 10 in the recess such that the adhesive 20 does not contact the interior surface of the recess. Such packages are disclosed, for example, in U.S. Pat. No. 5,172,809 (Jacobs et al.).

As yet another option, the container 22 may include a carrier having a pair of arms extending toward each other. Each of the arms has an outer end section, with the outer end sections being spaced apart from each other and presenting a channel therebetween. The appliance 20 is located in the channel and is supported by the arms, with one of the outer end sections extending into an occlusal recess beneath occlusal tiewings of the appliance 20 and the other of the outer end sections extending into a gingival recess beneath gingival tiewings of the appliance 20. Such constructions are described, for example, in U.S. Pat. No. 6,089,861 (Kelly et al.).

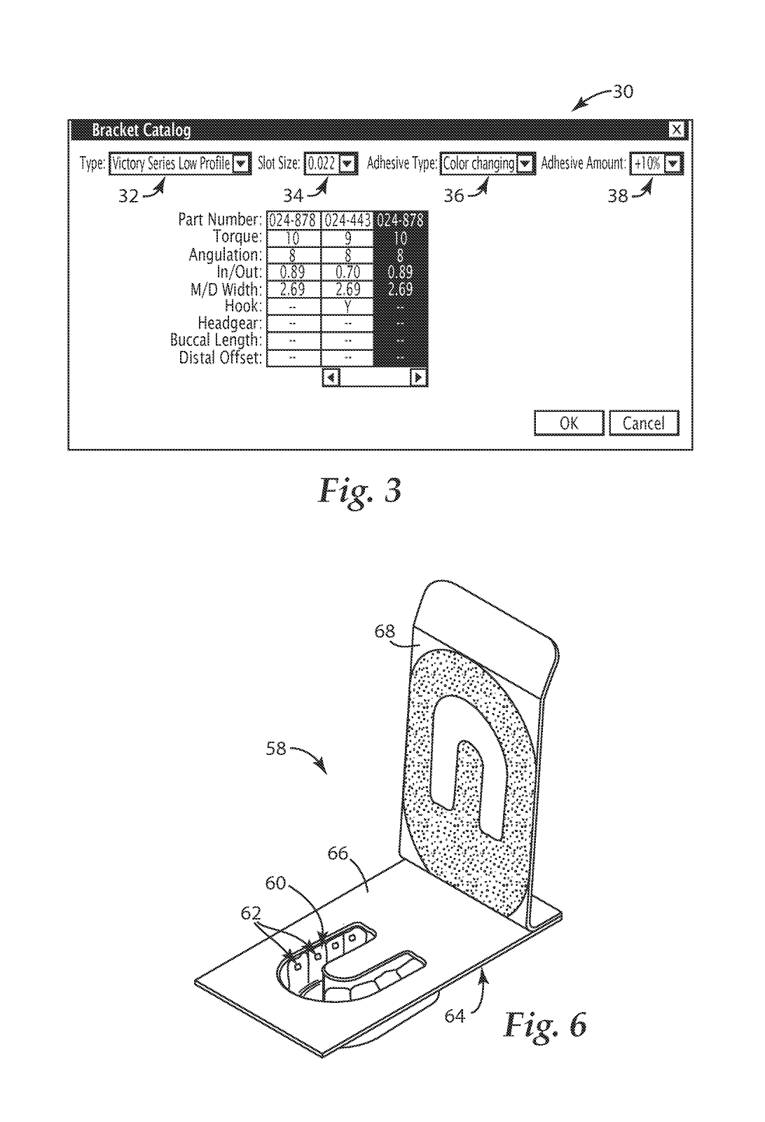

FIG. 3 is a display diagram illustrating an exemplary appliance and adhesive selection dialog 30 that serves as an interface to the orthodontic practitioner. Software provided to the practitioner may open the selection dialog 30 when, for example, the practitioner clicks on a “select bracket” or “change bracket” button of a template editing form for a particular tooth of the patient. The software provides an electronic template for ordering precoated appliances from the manufacturer, and preferably enables the practitioner to establish a custom template to increase the efficiency of ordering the appliances.

The templates are stored on a database that resides on a client computing device or alternatively in a location that is remote from the client computing device and coupled to the client computing device via a public or private network. The database includes a variety of data such as appliance data and adhesive data. The database also includes data defining default templates as well as custom templates mentioned above. The default or custom templates are retrieved by the practitioner when desired to order one or more adhesive precoated appliances from the manufacturer.

For example, and as shown in FIG. 3, the selection dialog 30 includes a drop-down menu 32 (which in this embodiment includes brand names for certain appliances) as well as a drop-down menu 34 for selection of the size of the archwire slot of the appliance. The dialog 30 also includes a drop-down menu 36 for selection of the type of adhesive and a drop-down menu 38 for selection of the quantity of adhesive to be applied to the selected appliance by the manufacturer before shipment to the practitioner.

Optionally, the selection dialog 30 may include a drop-down menu identifying other possible aspects of the appliances for selection by the practitioner. For example, the selection dialog 30 may include a drop-down menu that enables the practitioner to select an appliance by the type of composition used to make the appliance body (e.g., ceramic, plastic or metal). Other options for the appliance selection may include drop-down menus that enable the practitioner to select a size, overall shape, construction and/or composition of the appliance base.

The selection dialog 30 also shows examples of detailed attributes of appliances in the columns. In FIG. 3, the column on the right side of the drawing is darkened to represent a selected appliance. Each column displays a catalog number of an appliance, along with certain dimensions or other aspects of the appliance. Preferably, all of the appropriate appliance choices for the selected tooth, arranged such that one appliance appears per column, are shown in a scrollable list.

The type of adhesive as exemplified in the drop-down menu 36 of FIG. 3 may include a shortened description of the adhesive composition or one or more adhesive attributes, such as the various compositions mentioned above. Alternatively, or in addition to, the available choices of adhesive may include a listing of adhesives by brand name, catalog number or other designation, including brand names that identify a manufacturer other than the manufacturer that applies the selected adhesive 20 to the selected appliance 10. Optionally, a choice of one or more multi-layer adhesives may be provided, such as the multi-layer adhesives described in published U.S. Patent Application No. 2005/0136370 (Brennan et al.). As additional options, the act of selecting the orthodontic adhesive 20 may include the act of selecting one or more aspects from the following group: bond strength, curing mechanism, composition, color change upon hardening, color before hardening, viscosity, translucency, color after hardening, tack, refractive index, hydrophilicity, number of layers, patterns of layers, thickness of two or more layers and composition of layers. Other options for selecting the adhesive 20 are set out in published U.S. Patent Application No. 2006/0207893 (Cinader et al.).

The drop-down menu 38 associated with the words “adhesive amount” may be representative of possible quantities of the selected adhesive 20 as measured, for example, by weight or by volume. However, many practitioners may be unaware of the precise amount of adhesive that they prefer to use, in terms of weight or volume. For example, practitioners may have purchased adhesive precoated appliances from a certain manufacturer for many years without knowledge of the precise weight or volume of adhesive applied to the appliance by the manufacturer. Alternatively, the practitioner may have self-applied the adhesive to the base of the appliances using an “eyeball” test to roughly gauge whether or not the amount of adhesive appeared appropriate for the specific bonding procedure at hand.

Consequently, and in accordance with the present invention, a norm is established with respect to the amount of adhesive applied to a particular appliance. The norm may be calculated by determining a statistical average, mean or median value of the amount, or by calculating some other value that represents an average preferred amount of adhesive for any particular appliance when applied to a particular tooth. The norm may be calculated by reference to the weight of adhesive or to the volume of adhesive, or by some other characteristic that is representative of the adhesive amount. The norm may be established by reference solely to quantities of adhesive preferred by practitioners, quantities of adhesive recommended by manufacturers, or a combination of both.

For example, to establish a norm quantity of adhesive for a particular upper left cuspid bracket, a quantity of such brackets may be provided to a number of orthodontic practitioners. Each of the appliances is identical. However, the quantity of adhesive applied to the base of the brackets by the manufacturer varies from one bracket to the next. The practitioners are asked to bond each of the appliances to the same location on a number of identical teeth and record their preferences. The teeth may be, for example, identical models of an upper left cuspid tooth, where the model teeth were made using a digital data file representative of an average tooth configuration of the human population for an upper left cuspid tooth. Alternatively, the teeth may be actual upper left cuspid teeth of a number of different patients. The manufacturer then collects data regarding the practitioner's preferences to establish the norm.

Optionally, the drop-down menu 38 does not include numbers that indicate the precise weight or volume of the adhesive 20 (for example, in milligrams or milliliters) but instead provides values or indicia that are otherwise representative of the norm as well as deviations from the determined norm. For example, the drop-down menu 38 may include a text selection for “normal” or “standard”, or a number selection of “0” that represents the established norm. The menu 38 may also contain various incremental values or indicia such as +10%, +20%, +30% and −10%, −20% and −30% of the established norm. For instance, the indicia “+20%” may mean that the manufacturer will apply a weight (or volume) of adhesive to the selected appliance that is equivalent to 120% of the weight (or volume) of the established norm. Such listings may be more beneficial for some practitioners than a listing that provides the absolute values of the adhesive quantity by weight or volume. Alternatively, text such as “greater than normal” and “less than normal” may be provided.

Optionally, the selection dialog 30 provides a visual display that indicates previous adhesive selections made by the practitioner for a particular appliance 10. For example, if the practitioner has selected a ceramic bracket for an upper left cuspid tooth, the dialog 30 indicates the type of adhesive 20 and quantity of adhesive 20 that the same practitioner has previously chosen to be provided with that bracket. Optionally, those previous selections are used as defaults for the default template in instances when the practitioner does not take active steps using the dialog 30 to vary the type and quantity of adhesive 20 from past practice. As yet another option, the manufacturer's suggested adhesive type and adhesive quantity may appear and may be used as defaults, such as the word “normal” or the number “0” as described above.

As a further option, the software may enable the practitioner to ascribe a certain deviation from norm quantities of adhesive 20 and/or certain attributes of adhesive 20 to appliances 10 that are intended to be used in particular regions of the oral cavity. For example, the software may allow the practitioner to designate that all appliances 10 for posterior regions of the oral cavity should receive a greater than normal quantity of adhesive 20 and/or receive an adhesive 20 that is softer or less viscous than the viscosity of the adhesive 20 that is applied to the remainder of the appliances 10. The practitioner's past preferences with respect to the adhesive 20 used in certain regions of the oral cavity may be displayed in the selection dialog 30 and may be used as a default.

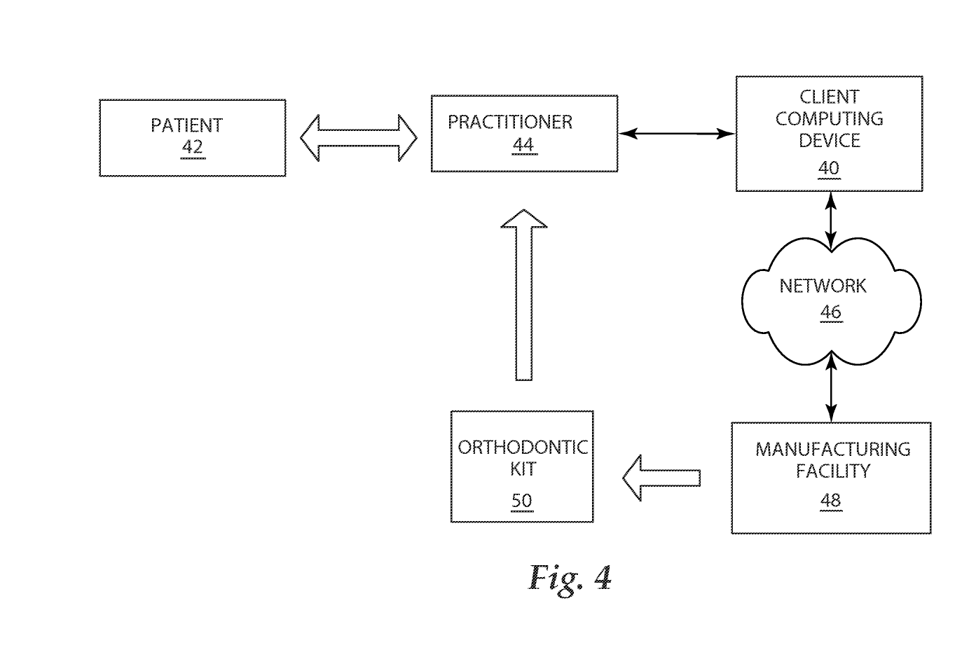

Preferably, the selection dialog 30 is displayed by modeling software that resides in a client computing device 40 as exemplified in FIG. 4. Optionally, the dialog 30 is communicated to the client computing device 40 over network 46. Preferably, the client computing device 40 presents an environment for modeling a representation of a dental arch of orthodontic patient 42. Preferably, orthodontic practitioner 44 is able to interact with the modeling software executing on the client computing device 40 to visualize the 3D representation of the dental arch of patient 42.

Optionally, the modeling software on the client computing device 40 may include an orthodontic appliance prescription template to assist the practitioner 44 in creating a patient-specific appliance prescription. Suitable orthodontic prescription forms, templates and toolbars as well as other aspects useful in carrying out the present invention are described in pending U.S. patent application Ser. No. 11/670,466 filed Feb. 2, 2007 (Raby et al.). In particular, and as modified for the present invention, the practitioner 44 may retrieve a stored electronic orthodontic prescription template from client computing device 40 or from a server via network 46 and then generate an orthodontic prescription that is specific to the teeth of the patient 42 by modifying one or more attributes of the appliance 10 and/or adhesive 20 of the template within the orthodontic modeling software.

Subsequently, the practitioner 44 may communicate the patient-specific orthodontic prescription over network 46 to a manufacturing facility 48. In response, the manufacturing facility 48 selects the desired appliances 10 and applies the desired amount of adhesive 20 to each respective appliance 10. The manufacturer then places each appliance 10 with the desired amount of pre-applied adhesive 20 in the respective container 22. All of the containers 22 for a single patient are then preferably placed by the manufacturer in a kit 50 along with other appliances, adhesives and/or other items as may be desired by the practitioner 44. The manufacturing facility 48 then ships the kit 50 to the practitioner 44. Optionally, the manufacturer applies the adhesive 20 to the appliances 10 but does not manufacture the appliances 10; instead, the appliances 10 are shipped to the manufacturer from another manufacturer or supplier.

FIG. 5 is an illustration of the kit 50 according to one embodiment of the invention. In this example, the kit 50 includes a holder 52 having a plurality of oval-shaped receptacles 54. Each of the receptacles 54 receives a respective container, such as the container 22 described above. As illustrated, the holder 52 may include a hinged cover and be made of boxboard.

Preferably, the holder 52 has a sufficient number of receptacles 54 and a sufficient number of containers 22 in the receptacles 54 so that an appliance (such as appliance 10) is provided for each of the patient's teeth undergoing treatment. For example, the holder 52 may contain receptacles 54 for each tooth of the upper and lower jaw, including the molar teeth. As another option and as shown, the holder 52 may be provided with a smaller number of receptacles 54, such as ten receptacles 54 for the non-molar teeth of the patient's upper jaw and ten receptacles 54 for the non-molar teeth of the patient's lower jaw. Alternatively, the kit 50 may include containers 22 with appliances 10 for only one jaw of the patient.

Optionally, the holder 52 serves as a set-up tray for chairside use by the practitioner. The holder 52 may also contain other items used in the bonding procedure, such as tooth etchants, adhesive primers, appliance placement gauges or jigs, single use hand instruments such as tweezers or positioning tools, articles for moisture control during the bonding procedure (such as cotton rolls), ligatures, archwires and the like. Examples of suitable holders are described in more detail in U.S. Pat. Nos. 5,575,645 (Jacobs et al.), 5,762,192 and 6,089,861 (Kelly et al.). Optionally, after packaging the kit 50 with the containers 22 and other desired items, the kit 50 is sealed and then sterilized as described for example in published U.S. Patent Application No. 2006/0424260 (Szwajkowski et al.).

An orthodontic kit 58 constructed according to another embodiment of the invention is shown in FIG. 6. The kit 58 includes a placement apparatus or indirect bonding tray 60 that is especially useful for indirect bonding procedures. The tray 60 has an interior channel with a configuration that matches the configuration of the patient's dental arch. A number of orthodontic appliances 62 are releasably connected to the bonding tray 60 in a location adjacent the channel. As the tray 60 is placed over the patient's dental arch, the appliances 62 are positioned on the patient's teeth at precise, predetermined positions as determined by the position of the appliances 62 in the channel. Exemplary indirect bonding trays and methods are described in published U.S. Pat. No. 7,137,812 (Cleary et al.) and pending U.S. patent application Ser. No. 11/689,845 filed Mar. 22, 2007 (Kim et al.).

The orthodontic appliances 62 provided in the indirect bonding tray 60 may have a single layer or multi-layer adhesive on the base of the appliances 62 or applied to a custom base of appliances 62. The appliances 62 and the applied adhesive may be similar to the appliance 10 and the adhesive 20 described above, and consequently a detailed description of those items need not be repeated. After the bonding tray 60 with the adhesive precoated appliances 62 has been made, the tray 60 is then placed in a container 64 by the manufacturer and shipped to the practitioner's office.

The container 64 includes a substrate 66 and a cover 102 that is releasably connected to the substrate 66. Preferably, the container 64 is comprised of a material similar to the materials used above to make the container 22, in that the resulting container 64 protects the adhesive that has been applied to the appliances 62 from light, moisture and contaminates. Additional aspects and alternatives for the bonding tray 60 and the container 64 are set out in U.S. Pat. No. 7,137,812 (Cleary et al.).

The complete disclosure of all patents and patent applications cited herein are incorporated by reference. The foregoing detailed description and examples have been given for clarity of understanding only. No unnecessary limitations are to be understood therefrom. The invention is not limited to the exact details shown and described, for variations obvious to ones skilled in the art will be included within the invention defined by the claims.

1. A method of manufacturing an adhesive precoated orthodontic appliance comprising:
selecting an orthodontic appliance and an orthodontic adhesive for bonding the appliance to a patient's tooth;
determining a quantity of the adhesive that is representative of a norm for bonding the selected appliance to an average tooth of a patient population;
providing an electronic template to an orthodontic practitioner that includes data representing the norm;
receiving an instruction from the orthodontic practitioner to send the selected appliance to the practitioner with a quantity of adhesive applied to the appliance that differs from the norm; and
shipping the appliance to the practitioner with a quantity of adhesive applied to the appliance that is in accordance with the practitioner's instruction.

2. A method of manufacturing an adhesive precoated orthodontic appliance according to claim 1 wherein the act of selecting an orthodontic appliance includes the act of identifying at least part of the composition of the appliance.

3. A method of manufacturing an adhesive precoated orthodontic appliance according to claim 1 wherein the act of selecting an orthodontic appliance includes the act of identifying an intended tooth to receive the appliance.

4. A method of manufacturing an adhesive precoated orthodontic appliance according to claim 1 wherein the act of selecting an appliance includes the act of identifying whether the appliance is intended to be bonded to a tooth in a posterior region or in an anterior region of the oral cavity.

5. A method of manufacturing an adhesive precoated orthodontic appliance according to claim 1 wherein the act of selecting an orthodontic appliance includes the act of identifying one or more aspects of a base of the appliance.

6. A method of manufacturing an adhesive precoated orthodontic appliance according to claim 5 wherein the aspects are selected from the following group: size of the base, overall shape of the base, construction of the base, and composition of the base.

7. A method of manufacturing an adhesive precoated orthodontic appliance according to claim 1 wherein the act of selecting an orthodontic appliance includes the act of identifying a brand name associated with the appliance.

8. A method of manufacturing an adhesive precoated orthodontic appliance according to claim 1 wherein the act of selecting an orthodontic adhesive includes the act of selecting one or more aspects from the following group: bond strength, curing mechanism, composition, color change upon hardening, color before hardening, viscosity, translucency, color after hardening, tack, refractive index, hydrophilicity, number of layers, patterns of layers, thickness of two or more layers and composition of layers.

9. A method of manufacturing an adhesive precoated orthodontic appliance according to claim 1 and including the act of identifying a default quantity of adhesive that will be applied to the appliance that is shipped to the practitioner if instructions from the practitioner are not received.

10. A method of manufacturing an adhesive precoated orthodontic appliance according to claim 1 wherein the act of receiving the instruction from the orthodontic practitioner includes the act of receiving information regarding the quantity of adhesive that is selected from a set of predetermined, incremental quantities of adhesive.

11. A method of manufacturing an adhesive precoated orthodontic appliance according to claim 10 wherein the incremental quantities of the set of predetermined, incremental quantities of adhesive are identified by at least one of the following: weight and volume.

12. A method of manufacturing an adhesive precoated orthodontic appliance according to claim 1 wherein the act of selecting an appliance is carried out by the orthodontic practitioner.

13. A method of manufacturing an adhesive precoated orthodontic appliance according to claim 1 and including the act of placing the selected appliance with the applied quantity of adhesive in a container that includes additional orthodontic appliances for the same patient.

14. A method of manufacturing an adhesive precoated orthodontic appliance according to claim 1 wherein the act of providing an electronic template to the practitioner includes the act of identifying a quantity of adhesive suggested by the manufacturer.

15. A method of manufacturing an adhesive precoated orthodontic appliance according to claim 1 wherein the act of providing an electronic template to the practitioner includes the act of identifying a quantity of adhesive previously selected by the practitioner.

16. A method of manufacturing an adhesive precoated orthodontic appliance according to claim 15 wherein the act of identifying a quantity of adhesive previously selected by the practitioner is also used as a default quantity of adhesive that will be applied to the appliance that is shipped to the practitioner if instructions from the practitioner are not received by the manufacturer.
